(19) United States
(12) Patent Application Publication
(10) Pub. No.: US 2026/0321039 A1
(43) Pub. Date: Oct. 15, 2026

(54) ORCHESTRATED PERCEPTUAL THOUGHT ITERATION FOR COGNITIVE VISUAL ANALYSIS

(71) Applicant: ABB Schweiz AG, Baden (CH)

(72) Inventors: Matthew Hetrich, Cary, NC (US); Stefan Rakuff, Garner, NC (US); Premith Kumar Chilukuri, Raleigh, NC (US)

(21) Appl. No.: 19/174,663

(22) Filed: Apr. 9, 2025

(51) Int. Cl. G06V 20/70; G06T 5/20; G06T 7/10

(52) U.S. Cl. CPC G06V 20/70; G06T 5/20; G06T 7/10; G06T 2207/20132

(57) ABSTRACT

An apparatus includes a processor and a memory including computer program code to: (i) receive an image and a query, (ii) generate one or more first perceptual thoughts related to one or more aspects of the image potentially relevant to the query, (iii) determine, for each first perceptual thought of the one or more first perceptual thoughts, an image processing action associated with the first perceptual thought, (iv) process the image according to each first image processing action to generate one or more filtered images from the image, (v) analyze the one or more filtered images to generate one or more second perceptual thoughts, (vi) generate, for each filtered image, a second perceptual thought related to one or more aspects of the filtered image potentially relevant to the at least one query, and (vii) generate, using the one or more second perceptual thoughts, a response to the query.

### BACKGROUND

The example and non-limiting embodiments relate generally to image processing through decomposition using vision-language models and, more particularly, to a sophisticated framework for context-aware, iterative processing of visual and textual information using computer vision, natural language, and machine reasoning to perform complex visual analysis tasks.

Vision-language models (VLMs) are widely used to process and provide understanding of video, image and textual inputs. Typical VLMs are comprised of a large language model (LLM) and a vision encoder. Additionally, VLMs typically include artificial intelligence (AI) multimodal models that can be trained using images and text. A trained VLM can receive text and images as input and generate text outputs.

### BRIEF DESCRIPTION

The following summary is merely intended to be an example. The summary is not intended to limit the scope of the claims.

In accordance with one aspect, an apparatus comprising at least one processor and at least one memory including computer program code is provided. The at least one memory and the computer program code is configured to, with the at least one processor, cause the apparatus at least to: (i) receive an image and at least one query, (ii) generate, using a first vision-language model, one or more first perceptual thoughts related to one or more aspects of the image potentially relevant to the at least one query, (iii) determine, for each first perceptual thought of the one or more first perceptual thoughts, a first image processing action associated with the first perceptual thought, (iv) process the image according to each first image processing action to generate one or more first filtered images from the image, (v) analyze, by the first vision-language model, the one or more first filtered images to generate one or more second perceptual thoughts, the first vision-language model configured to generate, for each first filtered image, a second perceptual thought related to one or more aspects of the first filtered image potentially relevant to the at least one query, and (vi) generate, using the one or more second perceptual thoughts, a response to the at least one query.

The at least one memory and the computer program code configured to, with the at least one processor, may further cause the apparatus to: (vii) analyze, by a second vision-language model, the one or more second perceptual thoughts, (viii) determine, by the second vision-language model, for a second perceptual thought associated with a corresponding first filtered image, a second image processing action to be applied to the corresponding first filtered image, (ix) process the corresponding first filtered image according to the second image processing action to generate a second filtered image, and (x) analyze, by the first vision-language model, the second filtered image to generate a third perceptual thought related to one or more aspects of the second filtered image potentially relevant to the at least one query, the response to the at least one query generated further based on the third perceptual thought.

In another aspect, a computer-based method is implemented using a computing device. The computing device may include at least one processor in communication with a memory device, and the method may include: (i) receiving an image and at least one query, (ii) generating, using a first vision-language model, one or more first perceptual thoughts related to one or more aspects of the image potentially relevant to the at least one query, (iii) determining, for each first perceptual thought of the one or more first perceptual thoughts, a first image processing action associated with the first perceptual thought, (iv) processing the image according to each first image processing action to generate one or more first filtered images from the image, (v) analyzing, by the first vision-language model, the one or more first filtered images to generate one or more second perceptual thoughts, the first vision-language model configured to generate, for each first filtered image, a second perceptual thought related to one or more aspects of the first filtered image potentially relevant to the at least one query, and (vi) generating, using the one or more second perceptual thoughts, a response to the at least one query.

The method may further include: (vii) analyzing, by a second vision-language model, the one or more second perceptual thoughts, (viii) determining, by the second vision-language model, for a second perceptual thought associated with a corresponding first filtered image, a second image processing action to be applied to the corresponding first filtered image, (ix) processing the corresponding first filtered image according to the second image processing action to generate a second filtered image, and (x) analyzing, by the first vision-language model, the second filtered image to generate a third perceptual thought related to one or more aspects of the second filtered image potentially relevant to the at least one query, the response to the at least one query generated further based on the third perceptual thought.

In accordance with one aspect, an apparatus comprising at least one processor and at least one memory including computer program code is provided. The at least one memory and the computer program code is configured to, with the at least one processor, cause the apparatus at least to: (i) generate, with a vision-language model, one or more first perceptual thoughts related to one or more aspects of an image and at least one query, (ii) create a filtered image for each of the one or more first perceptual thoughts based at least in part on the one or more first perceptual thoughts, (iii) generate, with the vision-language model, a second perceptual thought for each filtered image of the one or more first perceptual thoughts, and (iv) determine a response to the at least one query based at least in part on the one or more perceptual thoughts and the one or more second perceptual thoughts.

According to some aspects, there is provided the subject matter of the independent claims. Some further aspects are provided in subject matter of the dependent claims.

### BRIEF DESCRIPTION OF DRAWINGS

These and other features, aspects, and advantages of the present disclosure will become better understood when the following detailed description is read with reference to the accompanying drawings in which like characters represent like parts throughout the drawings.

FIG. 1 illustrates a block diagram of one possible and non-limiting example computing system in which the example embodiments may be practiced.

FIG. 2 illustrates a block diagram of one possible and non-limiting example computing device in which the example embodiments may be practiced.

FIGS. 3A and 3B illustrate an example flow diagrams in accordance with one or more embodiments of the disclosure.

FIGS. 4A and 4B illustrate an example implementation of at least one embodiment of the disclosure.

FIGS. 5A-5C illustrate an example implementation of at least one embodiment of the disclosure.

FIGS. 6A-6O illustrate example images in accordance with one or more embodiments of the disclosure.

### DETAILED DESCRIPTION

The following abbreviations that may be found in the specification and/or the drawing figures are defined as follows:
2D Two-Dimensional
3D Three-Dimensional
CPT Continued-Pre-training
LLM Large Language Model
SAM Segment Anything Model
SFT Supervised Fine-Tuning
VLM Vision Language Model
VRM Visual Reasoning Moderator

The disclosed systems and methods described herein relate to, among other things, the field of artificial intelligence, specifically vision-language models and cognitive computing. Disclosed embodiments herein combine computer vision, natural language processing, and machine reasoning to perform complex visual analysis tasks. In some embodiments, the system employs an iterative approach, integrating prompt-based image segmentation with dynamic thought generation and action planning. In some cases, one or more vision language models, or VLMs, are used to adaptively analyze visual inputs, gather relevant information, and refine their understanding through multiple reasoning steps. Additionally, the disclosed embodiments are applicable to various phases in the development and maintenance cycle of a product including new product development, customization and adaptation of existing products to new customer needs, and predictive and preventive maintenance of products. The disclosed embodiments advance the state-of-the-art in multimodal AI by offering a sophisticated framework for context-aware, iterative processing of visual and textual information, mimicking aspects of human cognitive processes.

VLMs face significant challenges when dealing with complex, information-rich images and nuanced queries. This makes it very challenging when using these models to address queries from an engineer or technician about engineering diagrams that may be found in standards, internal design documents, or product catalogs and technical drawings that may be used for documenting design and manufacturing process specifications. For example, existing VLMs lack the ability to handle and/or process large, detailed images, such as images with intricate details or extensive information, leading to incomplete or inaccurate analysis. In another example, VLMs lack iterative, focused analysis. Most VLMs analyze images in a single pass (i.e., 0-shot), thereby missing critical details and failing to refine their understanding over multiple iterations. In yet another example, VLMs have inefficient attention allocation. For example, VLMs often cannot dynamically focus on the most relevant parts of an image, leading to information overload and reduced accuracy. Even further, existing VLMs have the inability to break down complex visual tasks. For example, existing VLMs struggle to decompose intricate visual problems into manageable sub-tasks, limiting their problem-solving capabilities. In another example, VLMs lack limited integration of contrastive reasoning in that VLMs lack the ability to consider both supporting and contradicting evidence when analyzing visual scenes, leading to biased or incomplete interpretations. Another limitation of existing VLMs is that they operate as black boxes, making it difficult to understand or verify their decision-making process. Conventional VLMs often fail to handle ambiguous visual scenarios that require contextual understanding and/or multiple interpretations. Additionally, conventional VLMs struggle to combine insights from different parts, or regions, of an image to form a cohesive and detailed response. Further, conventional VLMs cannot adjust their analysis in an adaptive manner based on the nature or the complexity of a user's query.

The methods and systems described by the disclosed embodiments aim to address these problems by introducing an orchestrated, iterative approach to visual analysis that combines dynamic image segmentation, focused reasoning on image subsets, and aggregation of insights from multiple iterations to provide comprehensive and accurate responses to complex visual queries.

In the field of VLMs, several approaches have been proposed to integrate image segmentation with textual reasoning, though they face limitations in dynamic and iterative reasoning for complex image processing. Technical engineering drawings containing important design specifications of components, sub-assemblies, and assemblies are examples of such images. Solutions like LLM-Seg aim to bridge image segmentation and LLM reasoning, leveraging models like SAM to generate mask proposals for segmentation tasks. However, these approaches often operate in a static manner, processing the entire image without iterative refinement of reasoning based on segmentation outputs. LLM-Seg combines visual reasoning with segmentation, but it lacks the flexibility to adjust dynamically across multiple iterations, limiting its capability to handle highly detailed or evolving tasks. Other approaches, such as cross-modal attention-guided visual reasoning for referring to image segmentation, allow the system to identify and segment objects based on linguistic inputs, but these models focus primarily on localizing objects rather than iterative reasoning and refinement over time. Recent advancements attempt to introduce reasoning into segmentation by generating segmentation masks via LLMs, but their ability to handle complex reasoning over multiple iterations remains constrained. Overall, existing solutions demonstrate progress in segmentation and reasoning but fall short in providing a truly iterative, dynamically evolving framework that can progressively refine visual understanding that is required for correctly interpreting the information contained in images (e.g., photographs, video frames, technical drawings).

The present embodiments relate to systems and methods for solving complex visual reasoning tasks using an iterative, multi-stage analysis process. The embodiments described herein advanced VLMs with dynamic image segmentation and a sequence of “thought-action-observation” cycle based reasoning framework to provide detailed, context-aware responses to complex visual queries, which significantly improves the depth of visual comprehension, especially in scenarios where a single-pass analysis is insufficient.

In some embodiments, the disclosed systems and methods may be designed to process and analyze complex images containing large amounts of information or intricate details such as detail views, section views, form tolerances, location tolerances, and datum reference frames (in technical drawings) or legends, units, axis labels, and equations (in engineering diagrams). The disclosed systems and methods may employ a unique iterative approach that breaks down the analysis into multiple stages, each focusing on different aspects of the image and query. The core components of the disclosed system may include:
a) VLM: A neural network capable of processing both image and text inputs to generate textual outputs.
b) Prompt-Based Image Segmentation/Cropping Model: An advanced image segmentation tool (e.g., GroundingDINO+SAM) that can dynamically focus on specific parts of an image based on textual prompts.
c) VRM: A specialized variant of the VLM that orchestrates the analysis process, selecting the most relevant thoughts and actions, and determining when further analysis is required.

Unlike traditional vision-language models that process entire images at once, the embodiments described herein use an approach of dynamically segmenting the image based on the query and generated thoughts. This allows the system to focus on relevant parts of the image in detail, mimicking human visual attention mechanisms. For example, when the user query is related to dimensional information of a keyway or spline on a motor shaft, the model may focus on a cross-section view of the shaft at a certain location.

In some embodiments, improved handling of complex visual scenes may be provided. By breaking down complex images into manageable segments and analyzing each in detail, the disclosed methods can handle intricate visual scenes more effectively than traditional single-pass systems.

In some embodiments, enhanced contextual understanding may be provided. The disclosed iterative process allows the system to build a more nuanced understanding of the image, considering multiple perspectives and refining its interpretation over time. For example, the disclosed systems and methods may provide technical detail extraction. For example, the system may extract and interpret complex technical information, including precise measurements and tolerances, material specifications, manufacturing instructions, and functional requirements of different sections of a machine or part (e.g., different sections of a shaft).

In some embodiments, iterative reasoning may be provided. Unlike traditional models that process images in a single pass, the disclosed embodiments utilize a multi-step reasoning loop, allowing for deeper, more refined analysis. This iterative approach is crucial for understanding complex images with multiple layers of information. The disclosed can semantically break down arbitrary visual reasoning tasks allowing much more complex task decomposition compared to rigid, deterministic, or other non-semantic conceptualization.

In some embodiments, transparency and interpretability may be provided. For example, a structured Thought+Action framework and iterative process make the system's reasoning more transparent and interpretable, addressing the “black box” problem common in many Artificial Intelligence (AI) systems.

In some embodiments, dynamic segmentation and iterative analysis may be provided. Dynamic segmentation and iterative analysis allows the disclosed to adapt its approach based on the specific requirements of each query and image, making it highly versatile across different types of visual analysis tasks.

In some embodiments, improved accuracy in detail-oriented tasks may be provided. The system's ability to focus on specific image segments and perform multiple rounds of analysis makes it particularly well-suited for tasks requiring attention to fine details, such as technical drawing interpretation or medical image analysis.

In some embodiments, scalability to large and complex images may be provided. Unlike convention systems that struggle with very large or information-dense images, the disclosed embodiments provide a segmentation-based approach which allows it to efficiently process and analyze such images by breaking them down into manageable parts.

In some embodiments, context-aware segmentation may be provided. For example, by integrating a zero-shot object detection model (e.g., Grounding DINO) and a an image segmentation model (e.g., SAM), the framework allows for context-aware segmentation, where the model can isolate specific regions of interest within an image based on the query at hand. This makes the segmentation process more relevant and focused, leading to more accurate results.

In some embodiments, multimodal integration may be provided. The disclosed embodiments excel at integrating visual and textual data, making it highly effective for tasks that require an understanding of both modalities. This sets it apart from systems that focus solely on image segmentation or language processing in isolation.

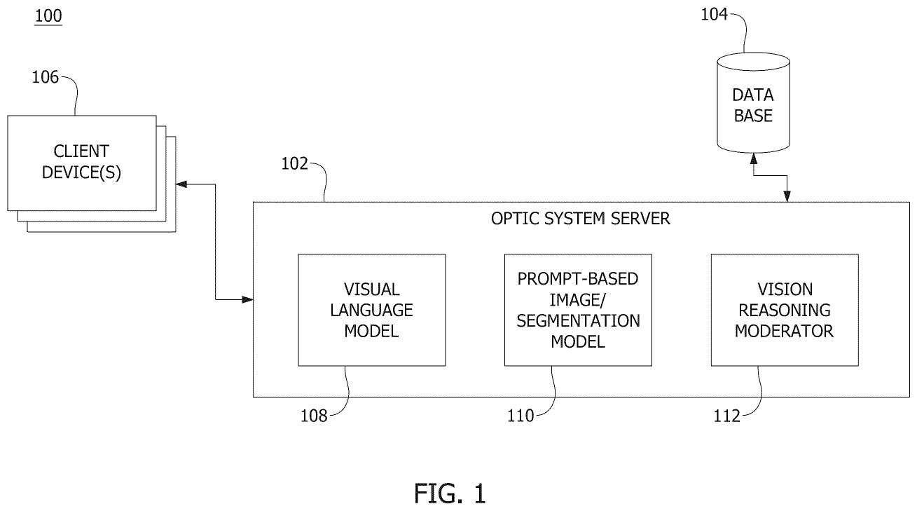

FIG. 1 depicts an example computing system 100. Computing system 100 may include an orchestrated perceptual thought iteration for cognitive visual analysis (OPTIC) system server 102. OPTIC system server 102 may be communicatively coupled to a database 104 that stores data. In one embodiment, database 104 may be a local storage device. In another embodiment, database 104 may be a remote storage device, such as cloud storage, or the like. OPTIC system server 102 may be in network communication with one or more client device(s) 106.

In an example embodiment, client device(s) 106 may be computers that include a web browser or a software application. Client device(s) 106 may access remote computer devices, such as OPTIC system server 102 using the Internet or another network. More specifically, client device(s) 106 may be communicatively coupled to OPTIC system server 102 through many interfaces including, but not limited to, at least one of a network, such as the Internet, a local area network (LAN), a wide area network (WAN), a cellular phone connection, and a cable modem. Client device(s) 106 may be any device capable of accessing the Internet including, but not limited to, a desktop computer, a laptop, a cellular phone, a smartphone, a tablet, or other web-based connectable equipment or mobile devices. Client device(s) 106 may include GPS sensors, image sensors, or the like. OPTIC system server 102 may receive user input data (e.g., image data and text prompts) from client device(s) 106. Further, OPTIC system server 102 may securely store the collected user input data on database 104. Output generated by OPTIC system server 102 based on the user input data may be sent to client device(s) 106. Additionally, or alternatively, OPTIC system server 102 may securely store the generated output on database 104. In some embodiments, a user of client device(s) 106 may receive a link to access the output generated based on their input on database 104.

OPTIC system server 102 may include a plurality of different models, such as neural network models, machine learning models, language models or the like. In this example for illustrative purposes, OPTIC system server 102 may include a first, second, and third model. The first model may be, for example, a vision language model (VLM) 108. The second model may be, for example, a prompt-based image/segmentation model (PBISM) 110. The third model may be, for example, a vision reasoning moderator (VRM) 112. In some embodiments, OPTIC system server 102 may implement methods as described herein for orchestrated perceptual thought iteration for cognitive visual analysis as described in more detail herein using VLM 108, PBISM 110 and VRM 112.

The first model, for example, VLM 108, may be a neural network capable of processing both image and text inputs. Based on the image and text inputs, the first model may process the image and text to generate text output that provides correlation between the image and text input. For example, the text input may be a user query about something displayed in the image or a request about what is displayed in the image. The user's query may be parsed using natural language processing (NLP) or the like to generate multiple thoughts, which are narrower, or more specific versions of the user's query. Different aspects of the image may be processed by the first model using one or more image processing techniques based on the parsed user query (e.g., object detection, text-box identification, optical character recognition (OCR), etc.). Additionally, or alternatively, the image processing may identify relevant portions, areas, or regions of interest (ROIs) within the image. As output, the first model may provide multiple thoughts where each thought indicates what was identified by the image processing (e.g., identified text, objects detected, etc.), where was it located in the image (e.g., relevant portions, areas, ROIs), and what part of the image should be focused on in more detail. For each thought that is generated by the first model, a corresponding “Action+Segmentation Prompt” may be generated. An example Action+Segmentation Prompt may be created based on the corresponding thought indicating how the input image may be cropped or segmented. For example, if a first thought indicates a ROI on the left side of an image where a certain object is detected, the corresponding Action+Segmentation Prompt may be “crop center section and right section of image.” If a second thought indicates a ROI on the top portion of the image, the corresponding Action+Segmentation Prompt may be “crop bottom 60% of image.”

The second model, for example, PBISM 110, may be a prompt-based image segmentation/cropping model. Continuing with the example above, the second model may accept, as input, the image provided by the user and the generated segmentation prompts (e.g., “crop center section and right section of image” and “crop bottom 60% of image”). The second model may then, using the segmentation prompts as instructions, create a new image for each of the segmentation prompts. For example, for the first prompt, a first image may be created that only includes the left section of the original image. Further, for the second prompt, a second image may be created that only includes the right section of the original image. The second model may provide the first and second image, which may be focused areas, or regions, of the original image as output.

Continuing with the example, the first image and the second image may be processed by the first model, such as VLM 108, again. Different aspects of the image may be processed by the first model using one or more image processing and/or vision techniques such as object detection, text-box identification, optical character recognition (OCR), or the like. Additionally, or alternatively, the image processing may identify relevant portions, areas, or regions of interest (ROIs) within the image. As output, the first model may provide information about each image based on analysis and reasoning. Information about each image may include more specific details and analysis when compared to analysis of the original image by the first model. In some embodiments, the information, which may be referred to as “Thought+Action” pairs, may include additional data about the focused areas of the image, such as text that may be determined to be meaningful (e.g., measurements in a technical drawing, a model number).

The third model, for example, VRM 112, may be a neural network that is a variant of VLM 108. Continuing with the example, the third model may accept, as input, the first image's thought+action pair, the second image's thought+action pair, and the original user input. In some embodiments, the relevance of each thought+action pair to the original user query may be determined. Additionally, or alternatively, the third model may determine, based on its relevance, whether each thought+action pair is necessary. In the event that a thought+action pair is deemed unnecessary, it may be removed. Even further, the third model may determine that a thought+action pair may require further analysis. Continuing with the example, it may be determined by the third model that the thought+action pair that corresponds to the second image is not only relevant to the original input query, but may also require further analysis. In this instance, the second image and its corresponding thought+action pair may be used as input for an additional iteration (e.g., processing by the first, second, and third models to generate additional thoughts, focused images, and thought+action pairs). Any number of the thought+action pairs may be sent for an additional iteration. For example, the first and second image, along with their corresponding thought+action pairs, may be sent for an additional iteration, only one of them may be sent, or neither of them may be sent. Results from each iteration may be aggregated, refined, and stored for subsequent retrieval. In some cases, further iterations may be performed, causing new and more focused thoughts and segmentation prompts to be generated. Once it is determined by the third model that no further analysis is required, all relevant information gleaned from all iterations may be aggregated to generate a comprehensive final response to the original input query provided by the user.

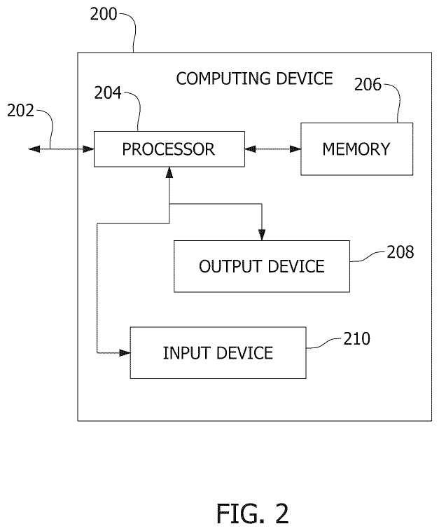

FIG. 2 depicts an example configuration of a computing device 200, in accordance with an embodiment of the present disclosure. Computing device 200 may be operated by a user. Computing device 200 may include, but is not limited to, client device(s) 106 and/or OPTIC system server 102 (shown in FIG. 1). As an example, computing device 200 of the user may be a smartphone or other portable computer device (e.g., a tablet or a laptop).

Computing device 200 may include processor 204, memory 206, output device 208, and input device 210.

Input to computing device 200 may be provided by input device 210, provided from an input device in communication with computing device 200 via link 202 (e.g., a wired link or a wireless link; e.g., with a direct connection or over a network), and/or provided from another computer(s) in communication with computing device 200 via link 202.

Output for computing device 200 may be provided by output device 208, provided to an output device in communication with computing device 200 via link 202, and/or provided from another computer(s) in communication with computing device 200 via link 202. Output device 208 may include one more displays and one or more speakers. Output device 208 may display output generated by the system according to one or more embodiments described herein.

In some embodiments, input device 210 and output device 208 may be combined into one or more unitary input/output devices (e.g., a touch screen on a smartphone).

In some embodiments, based on input from input device 210 or input from outside computing device 200 via link 202, processor 204 may perform operations as described herein. As an example, user input may be received from input device 210. As an example, input may be from another computer in communication with computing device 200 via link 202. As an example, input may be from an input device in communication with computing device 200 via link 202. In some embodiments, a user may provide an input image or an input query using an input device (e.g., a keyboard, a graphical user interface) via link 202. Additionally, or alternatively, a user may provide a query via an input device (e.g. a microphone) using voice-to-text via link 202. In yet another embodiment, an input image may be provided using a camera as an input device via link 202.

In some embodiments, processor 204 may perform operations as described herein and provide results of the operations as output. As an example, output may be provided to output device 208. As an example, output may be provided to another computer in communication with computing device 200 via link 202. As an example, output may be provided to an output device in communication with computing device 200 via link 202. Results generated by VLM 108, PBISM 110, and VRM 112 may be provided on a display screen of a computing device 200 via link 202. Additionally, user feedback may be provided via an input device in response to the generated results. A final response as described herein may also be provided on a display screen of a computing device 200 via link 202.

Memory 206 may be accessible by processor 204 so that processor 204 may read information from and write information to memory 206. Memory 206 may store instructions that, when executed by processor 204, implement embodiments described herein. Memory 206 may be a non-transitory computer readable medium (or a non-transitory processor readable medium) containing a set of instructions thereon for enhancing audio in a recorded video, wherein when executed by a processor (such as processor 204), the instructions cause the processor to perform methods discussed herein. As an example, computing device 200 may be a smartphone, and memory of the smartphone may store a software application to perform embodiments described herein. For example, memory 206 may include software instructions configured to implement the embodiments described above with respect to VLM 108, PBISM 110 and VRM 112. Additionally, or alternatively, memory 206 may be used to store user input data (e.g., images, text-based queries), results generated by VLM 108, PBISM 110 and VRM 112, or the like.

Computing device 200 may be an apparatus for implementing a multi-stage iterative process to analyze images and respond to queries, the apparatus including: one or more processors (such as processor 204); and memory (such as memory 206) accessible by the one or more processors, the memory storing instructions that when executed by the one or more processors, cause the apparatus to perform one or more methods described herein.

Memory 206 may be a non-transitory processor readable medium containing a set of instructions thereon for implementing a multi-stage iterative process to analyze images and respond to queries wherein when executed by one or more processors (such as processor 204), the instructions cause the one or more processors to perform one or more methods described herein.

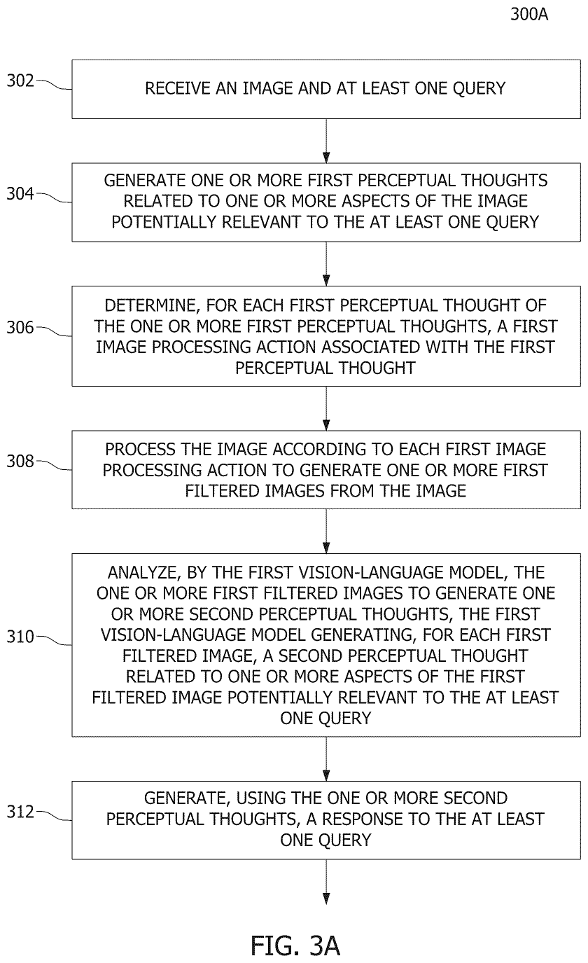

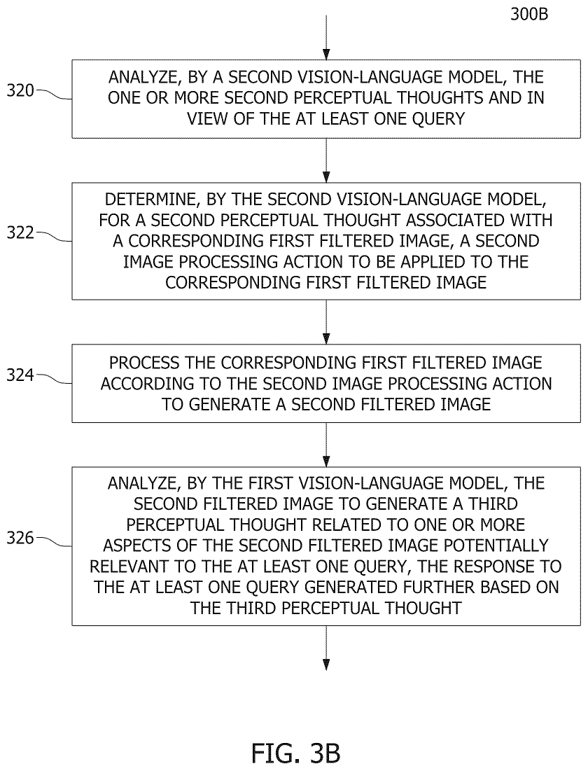

FIGS. 3A and 3B illustrate example methods 300A and 300B of orchestrated perceptual thought iteration for cognitive visual analysis. Methods 300A and 300B may be implemented by computing device 200 (shown in FIG. 2) where computing device 200 is an instance of OPTIC system server 102 (shown in FIG. 1). While FIGS. 3A and 3B will be discussed in the context of FIGS. 1 and 2, this is for clarity of explanation purposes only and the method described in FIGS. 3A and 3B should not be considered limited by the components illustrated in FIGS. 1 and 2.

Method 300A of FIG. 3A and method 300B of FIG. 3B provide an example multi-stage iterative analysis process to analyze images and respond to a query. The methods may be implemented by a processor, such as processor 204 of FIG. 2. For example, at 302, method 300A may include processor 204 receiving an image and at least one query, such as a question about the image or a request for a detailed explanation of what is shown in the image. For example, in some embodiments a user via a client device, such as client device 106 shown in FIG. 1, may submit a text-based query along with an image. In one non-limiting example, the image may show a picture of cats in an alley and the query may be “Tell me about the cats in the photo.”

Method 300A, at 304, may include processor 204 generating, using a first vision-language model, one or more first perceptual thoughts related to one or more aspects of the image potentially relevant to the at least one query. The visual-language model may be VLM 108 shown in FIG. 1. In some embodiments, the first vision-language model is a neural network trained to relate one or more aspects of an input image to a text-based input query. The one or more perceptual thoughts may be multiple “thoughts” that relate to different aspects of the image that may be relevant to the at least one query. Continuing with the non-limiting example, the VLM, through visual analysis, may determine that the image shows ten cats in an alley. Based on this analysis, and in view of the query, three perceptual thoughts may be generated: 1) how many cats are on the left side of the alley, 2) how many cats are in the middle of the alley, and 3) how many cats are on the right side of the alley.

Method 300A, at 306, may include processor 204 determining, for each first perceptual thought of the one or more first perceptual thoughts, a first image processing action associated with the first perceptual thought. An image processing action may be, for example, an instruction to crop or segment a portion of an image (e.g., crop center and right portion of image) in relation to a perceptual thought (e.g., focus on left portion of image). In some embodiments, the first processing action includes an instruction to segment or crop an image to generate a filtered image. Continuing with the non-limiting example, an image processing action is determined for each perceptual thought: 1) crop middle and right segments, 2) crop left and right segments, and 3) crop left and middle segments.

Method 300A, at 308, may include processor 204 processing the image according to each first image processing action to generate one or more first filtered images from the image. In one example, the image may be processed by an image segmentation model, such as PBISM model 110 shown in FIG. 1. The PBISM model may dynamically segment or crop the input image based on the first image processing actions, creating multiple filtered images that focus on specific areas or features of the image relevant to each perceptual thought. Continuing with the non-limiting example, three filtered images are generated: 1) image showing left segment, 2) image showing middle segment, and 3) image showing right segment.

Method 300A, at 310, may include processor 204 analyzing, by the first vision-language model, the one or more first filtered images to generate one or more second perceptual thoughts, the first vision-language model generating, for each first filtered image, a second perceptual thought related to one or more aspects of the first filtered image potentially relevant to the at least one query. The second perceptual thoughts may represent the system's analysis and reasoning about each focused area of the image. Continuing with the non-limiting example, when comparing a first perceptual and a second perceptual thought, the first perceptual thought provides analysis of the entire image whereas the second perceptual thought, or thoughts, provide analysis of just a portion of the entire image (e.g., a left segment or right segment). By only analyzing a portion of the original image, the VLM is able to provide a more detailed analysis of what is shown in the image. For example, a first perceptual thought may summarize what is shown in a photo (e.g., “The image shows ten cats in an alley”) and second perceptual thoughts may provide more details about the cats in different portions of the image: 1) there are three cats on the left side of the alley, 2) there are no cats in the middle of the alley, and 3) there are seven cats on the right side of the alley there are seven cats on the right side of the alley towards the bottom of the photo.

Method 300A, at 312, may include processor 204 generating, using the one or more second perceptual thoughts, a response to the at least one query. In some embodiments, insights from the second perceptual thoughts which correspond to different sections of an image, or a drawing, may be combined to form a comprehensive understanding of the image or drawing and be provided as a response to the user's query. Continuing with the example above, an example response may be: “The photo shows ten cats in an alley, three on the left side of the alley and seven on the right.”

Method 300B, at 322, may include processor 204 determining, by the second vision-language model, for a second perceptual thought associated with a corresponding first filtered image, a second image processing action to be applied to the corresponding first filtered image. The second image processing action may be, for example, an instruction to crop or segment a portion of an image in relation to the second perceptual thought. Continuing with the non-limiting example, an image processing action may be created for the second perceptual thought “there are seven cats on the right side of the alley towards the bottom of the photo.” The image processing action may be, for example, “crop top 40% of image.”

In some embodiments, the second vision-language model is a VRM, such as VRM 112 shown in FIG. 1. In some embodiments, the VRM may evaluate the one or more second perceptual thoughts (e.g., “Thought+Action” pairs) generated by the VLM. The VRM may perform several crucial functions including selecting the most appropriate and relevant thoughts and actions for the user's query, determining which Thought+Action pairs require further analysis, aggregating the information from multiple iterations into a coherent understanding, and initiating further iterations of analysis.

In some embodiments, the one or more second perceptual thoughts may be analyzed by ranking the one or more second perceptual thoughts from most to least relevant to the at least one query, identifying any contradictions or complementary information among the one or more second perceptual thoughts, or suggesting how to combine insights from the one or more second perceptual thoughts to form a comprehensive understanding. Ranking from most to least relevant may include calculating a relevancy score for each perceptual thought indicating how relevant each thought is to the at least one query. Calculating a relevancy score may, in one example, be performed by the VRM using NLP in comparing the information detailed by a perceptual thought and the at least one query. Identifying contradictions or complementary information may include comparing perceptual thoughts to one another and determining how they may relate, or not relate, to one another. Suggesting how to combine insights to form a comprehensive understanding may include, in the event two perceptual thoughts provide similar information, the two perceptual thoughts may be combined into one perceptual thought. Alternatively, one of the two perceptual thoughts may be discarded.

In some embodiments, the system may consider the observations and insights from previous iterations. In some cases, the prior observations may include results of the segmentation or feature extraction and serve as feedback for the reasoning process. The VRM may, for example, analyze whether the observation answers the query or if further refinement is needed. Additionally, or alternatively, the VRM may generate new, more focused thoughts and segmentation prompts that may be used during a future iteration. As an example, the VRM may indicate whether further analysis is, or is not, needed using a decision mechanism.

Method 300B, at 324, may include processor 204 processing the corresponding first filtered image according to the second image processing action to generate a second filtered image. In one example, the image may be processed by an image segmentation model, such as PBISM model 110 shown in FIG. 1. The PBISM model may dynamically segment or crop the first filtered image based on the second image processing action, creating a second filtered image that focuses on a specific area or feature of the image relevant to the second perceptual thought. In some embodiments, a first prompt to trigger the first image processing action may be determined for each first perceptual thought of the one or more first perceptual thoughts. Continuing with the non-limiting example, the image may be cropped based on the instruction “crop top 40% of image.”

Method 300B, at 326, may include processor 204 analyzing, by the first vision-language model, the second filtered image to generate a third perceptual thought related to one or more aspects of the second filtered image potentially relevant to the at least one query, the response to the at least one query generated further based on the third perceptual thought. Continuing with the non-limiting example, the third perceptual thought may indicate “there are seven cats on the right side of the alley, three of which are lying down.” In some embodiments, insights from the third perceptual thought and the second perceptual thoughts which correspond to different sections of an image, or a drawing, may be combined to form a comprehensive understanding of the image or drawing and provided as a response to the user's query. Continuing with the non-limiting example, the response may indicate: “The photo shows ten cats in an alley, three on the left side of the alley and seven on the right. Three of the cats on the right side of the alley are lying down.” While FIGS. 3A and 3B illustrate a first iteration and a second iteration, respectively, it is understood that multiple iterations may be performed, as described in the use case examples.

The disclosed multi-stage iterative process allows for progressive refinement of understanding. Each iteration builds upon the insights from previous rounds, allowing the system to delve deeper into complex aspects of the image and query. In some embodiments, a memory buffer may be maintained to store insights from previous iterations. For example, a memory buffer may be maintained in memory 206 as shown in FIG. 2.

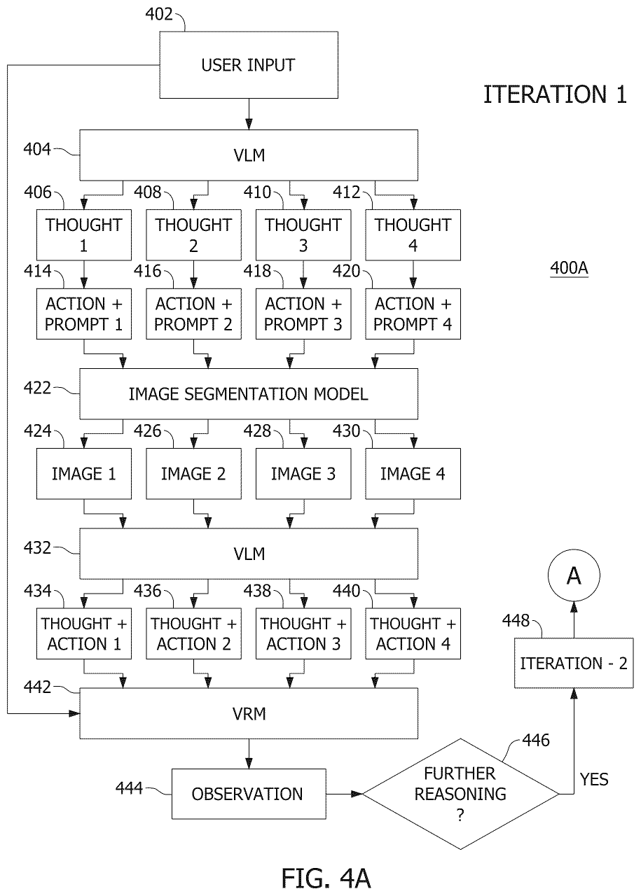

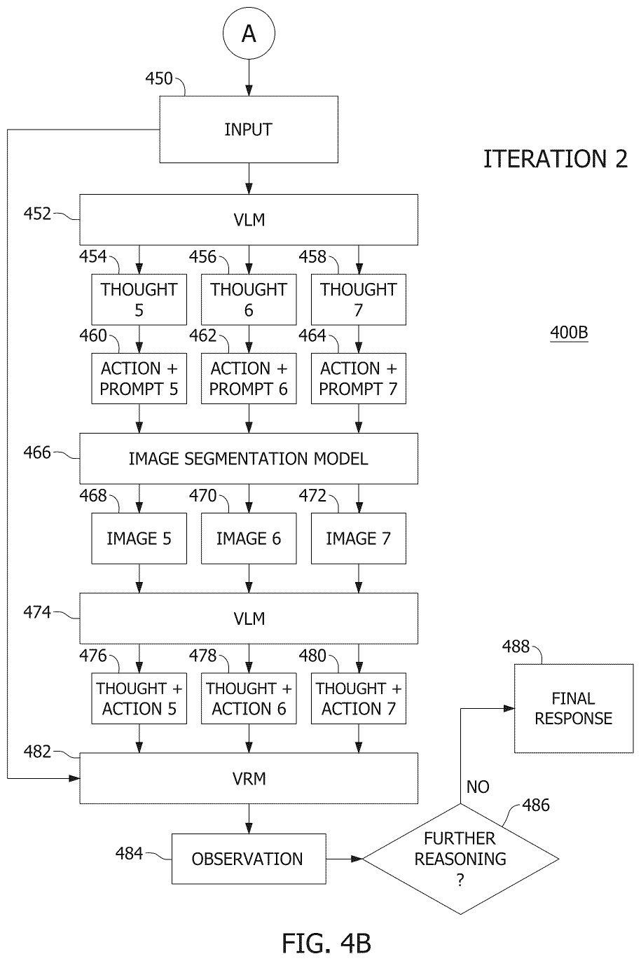

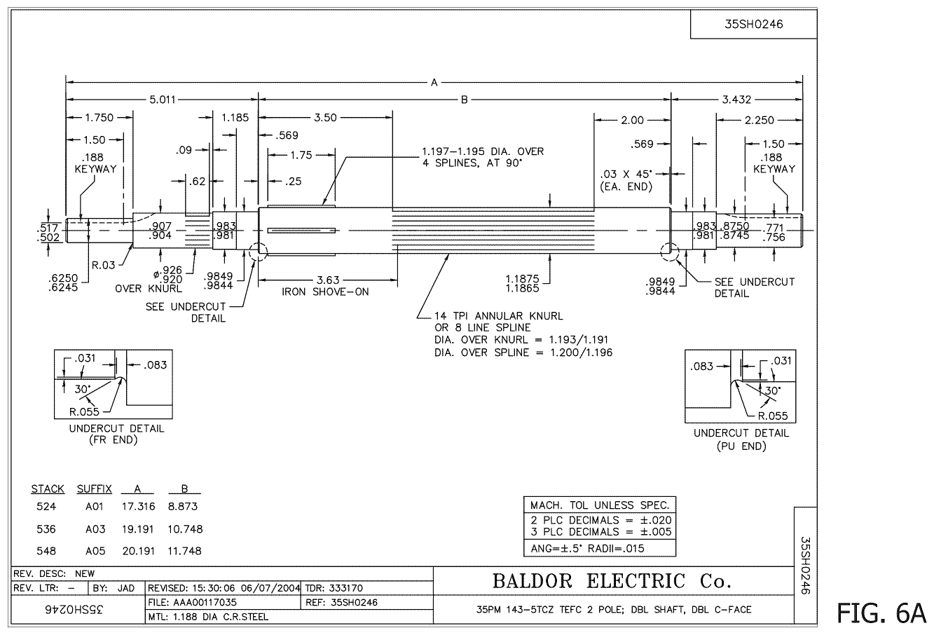

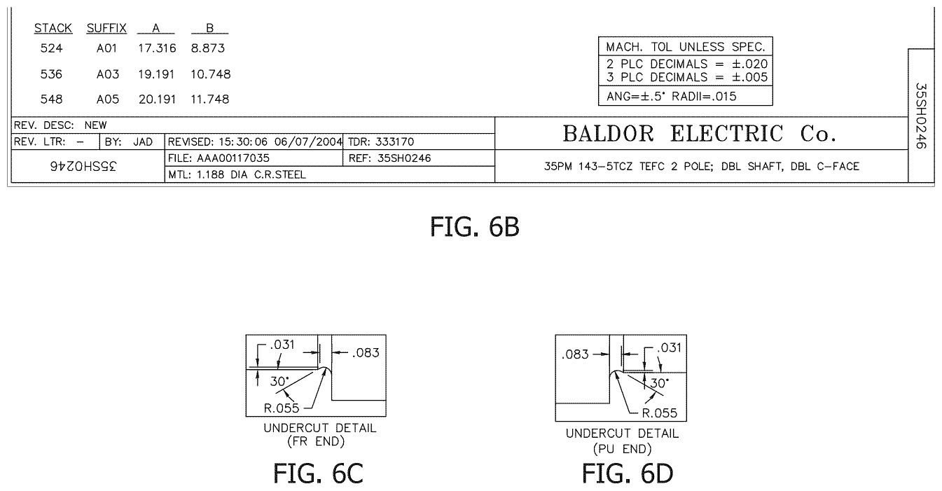

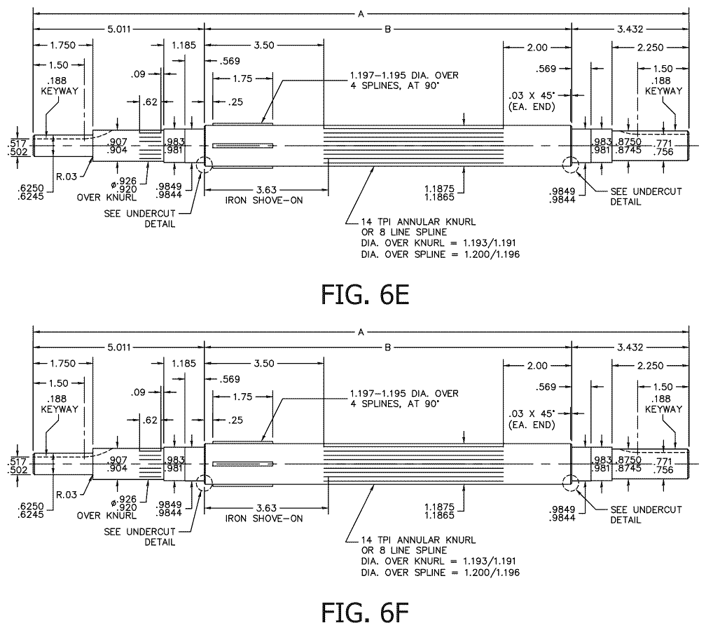

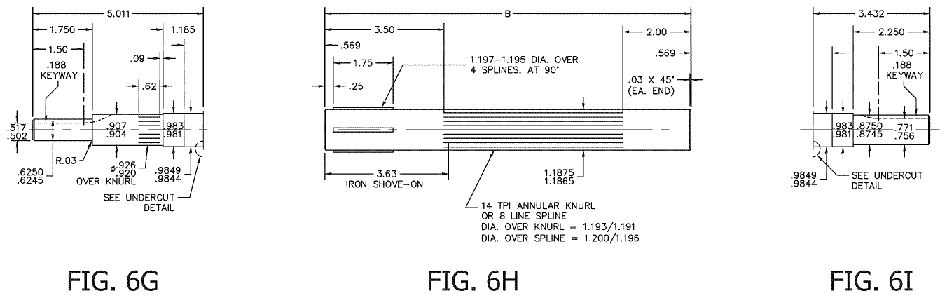

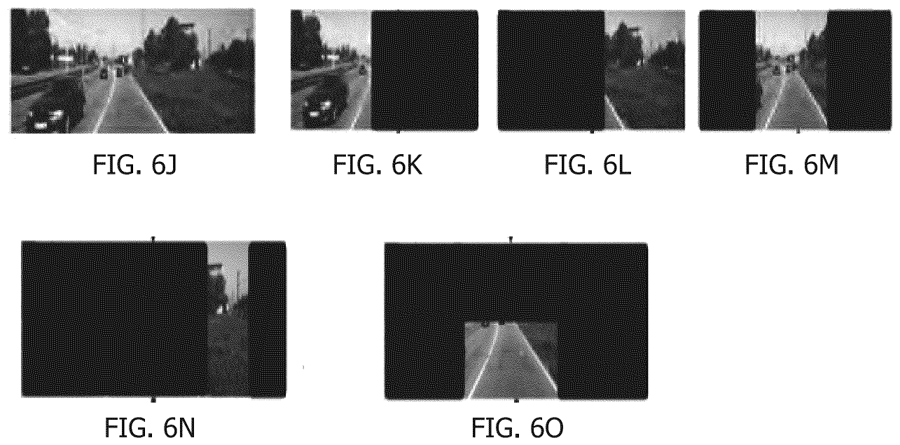

Turning to FIGS. 4A and 4B, a detailed example in accordance with one embodiment is provided of analysis of a technical drawing. The detailed example shows how the disclosed systems and methods are able to handle complex, information-rich images. The flow diagrams of method 400A and method 400B refer to sample images provided in FIGS. 6A-6H. Methods 400A and 400B may be implemented by processor 204 of computing device 200 (shown in FIG. 2) where computing device 200 is an instance of OPTIC system server 102 (shown in FIG. 1). In this example, analysis is performed of a 2D technical drawing of a shaft design illustrated in FIG. 6A. FIG. 4A, method 400A, is a first iteration which analyzes each segment of an input image for key components and measurements. FIG. 4B, method 400B, is a second iteration which provides detailed analysis of specific features, tolerances, and manufacturing notes.

Method 400A, at 402, includes processor 204 receiving user input. The user input includes a query (“Give me a detailed description of the 2D shaft design in the image”) and an image (2D technical drawing of a shaft design (see FIG. 6A).

Method 400A, at 404, includes processor 204 providing the user input to a VLM, such as VLM 108 described herein and above. The VLM provides four “thoughts” based on visual reasoning and analysis of the input image and the input query, Thought-1 406, Thought-2 408, Thought-3 410 and Thought-4 412.
Thought-1: Analyze the overall 2D shaft drawing
Thought-2: Analyze on the left end of the shaft
Thought-3: Examine the central portion
Thought-4: Analyze the right end of the shaft

Processor 204 creates segmentation prompts for each thought, Action+Prompt-1 414, Action+Prompt-2 416, Action+Prompt-3 418, and Action+Prompt-4 420.
Action+Prompt-1: Crop the top 70% of the input image, such that, only bottom 30% is visible
Action+Prompt-2: Crop the “FR END undercut” part of the input design
Action+Prompt-3: Crop the “PU END undercut” part of the input design
Action+Prompt-4: Crop the bottom 40% of the input image, such that, only top 60% is visible

Method 400A, at 422, includes processor 204 providing four Action+Prompts 414, 416, 418 and 420 and the input image (FIG. 6A) to an image segmentation model, such as PBISM 110 described herein. The image segmentation model, using the instructions provided by four Action+Prompts 414, 416, 418 and 420, generates four images 424, 426, 428 and 430, examples of which are illustrated in FIGS. 6B, 6C, 6D and 6E, respectively. The four images illustrate different regions of interest of the original input image shown in FIG. 6A.

Method 400A, at 432, includes processor 204 providing four images 424, 426, and 430 as input to the VLM for processing. At 432, the four images are subjected to visual processing as described herein in conjunction with VLM 108. A “Thought+Action” is generated by the VLM for each input image. For example, Thought+Action-1 434, Thought+Action-2 436, Thought+Action-3 438, and Thought+Action-4 440, are generated for images 424, 426, 428 and 430, respectively.
Thought+Action-1: The 2D shaft CAD diagram metadata belongs to a component manufactured by Baldor Electric Co., specifically model 35PM 143-5TCZ TEFC 2 POLE with a double shaft and double C-face configuration. The diagram provides three stack configurations: Stack 524 with suffix A01 has measurements A=17.316 and B=8.873, Stack 536 with suffix A03 has A 19.191 and B=10.748, and Stack 548 with suffix A05 has A=20.191 and B=11.748. The material used for the shaft is specified as 1.188 DIA C.R. Steel. The machining tolerances are ±0.020 for two-place decimals, +0.005 for three-place decimals, with angular tolerance ±0.5°, and radius tolerance of ±0.015. The revision description is marked as “NEW,” revised on Jun. 7, 2004 at 15:30:06 by JAD, with revision tracking number TDR: 333170, file AAA00117035, and reference number 35SH0246.
Thought+Action-2: The FR (Front) End undercut detail of the 2D shaft CAD diagram features a precision-machined undercut with a radius of 0.055 and an angle of 30°. The vertical dimension of the undercut is 0.031, and the horizontal clearance to the right of the undercut is 0.083. These specifications are crucial for the accurate fabrication of the shaft's front end, ensuring that the undercut is shaped to the exact required tolerances.
Thought+Action-3: The PU (Power Unit) End undercut detail of the 2D shaft

CAD diagram shows a precise undercut with a radius of 0.055 and an angular cut of 30°. The vertical dimension of the undercut is 0.031, and the horizontal clearance to the left of the undercut is 0.083. These details are essential for the accurate machining and assembly of the shaft's power unit end, ensuring that the undercut conforms to the required tolerances for functionality and fit.
Thought+Action-4: The lateral view of the 2D shaft CAD diagram details the shaft's dimensions and features. It includes two keyways, each 0.188 inches wide and 1.50 inches long, located at both ends. The left side has diameters ranging from 0.517 to 0.502 inches, with a 0.03-inch radius undercut, followed by a knurled section with diameters between 0.926 to 0.920 inches. The central spline section has a diameter of 1.197 to 1.195 inches over 4 splines at 90°. The iron shove-on section is 3.63 inches long, with diameters from 0.983 to 0.981 inches. The shaft ends feature chamfers of 0.03×45°, ensuring proper fitment. The diameters across various sections are precisely controlled for accurate assembly and function.

Method 400A, at 442, includes processor 204 providing the user query of 402 and four “Thought+Action” pairs 434, 436, 438 and 440 as input to a VRM, such as VRM 112 described herein. The VRM performs evaluation of the user query of 402 and four “Thought+Action” pairs 434, 436, 438 and 440 to generate an observation, such as observation 444.

Observation 444: The diagrams provide detailed undercut and dimensional data for the shaft's front and power unit ends. While the undercut details are straightforward, the complete shaft diagram in the fourth {thought+Action} pair requires further analysis due to its complex sections, including keyways, knurls, splines, and chamfers, which are critical for proper assembly and functionality.

At 446, it is determined that further reasoning is required (“YES”). In this example, “Thought+Action” pair 440 is determined to require further analysis. At 448, “Thought+Action” pair 440 and its corresponding image 430 are sent for a new iteration, which is described in FIG. 4B, method 400B.

Method 400B, at 450, includes processor 204 receiving input. The input includes the original query (“Give me a detailed description of the 2D shaft design in the image”), observation 444, Thought+Action pairs of previous iterations (e.g., 434, 436, 438, 440) and image 430 (see FIG. 6F).

Method 400B, at 452, includes processor 204 providing the input to a VLM, such as VLM 108 described herein and above. The VLM provides three “thoughts” based on visual reasoning and analysis of the input provided at 450: Thought-5 454, Thought-6 456 and Thought-7 458.
Thought-5: For a detailed analysis of the lateral view of the 2D shaft diagram, let us dissect the diagram and focus on the left part of the shaft
Thought-6: For a detailed analysis of the lateral view of the 2D shaft diagram, let us dissect the diagram and focus on the center part of the shaft
Thought-7: For a detailed analysis of the lateral view of the 2D shaft diagram, let us dissect the diagram and focus on the right part of the shaft

Processor 204 creates segmentation prompts for each thought, Action+Prompt-5 460, Action+Prompt-6 462 and Action+Prompt-7 464.
Action+Prompt-5: Crop center and right sections of the image
Action+Prompt-6: Crop left and right sections of the image
Action+Prompt-7: Crop center and left sections of the image

Method 400B, at 466, includes processor 204 providing the three Action+Prompts and image 430 to an image segmentation model, such as PBISM 110 described herein. The image segmentation model, using the instructions provided by the three Action+Prompts, generates three images 468, 470 and 472, examples of which are illustrated in FIGS. 6G, 6H, and 6I, respectively. The three images illustrate different regions of interest of the input image 430 shown in FIG. 6F.

Method 400B, at 474, includes processor 204 providing three images 468, 470 and 472 as input to the VLM for processing. At 474, three images 468, 470 and 472 are subjected to visual processing as described herein in conjunction with VLM 108. A “Thought +Action” is generated by the VLM for each input image. For example, Thought+Action-5 476, Thought+Action-6 478 and Thought+Action-7 480, are generated for images 468, 470 and 472, respectively.
Thought+Action-5: The left section of the 2D shaft diagram starts with a 0.188-inch wide and 1.50-inch long keyway, with shaft diameters ranging from 0.517 to 0.502 inches. It includes an undercut with a 0.03-inch radius, followed by a knurled section with diameters between 0.926 and 0.920 inches. This knurled portion spans 1.750 inches, transitioning to a segment with diameters of 0.907 to 0.904 inches. The overall length from the left end to this transition is 5.011 inches. The final section features diameters of 0.983 to 0.981 inches, with references to further undercut details, ensuring proper keying and fitment in the assembly.
Thought+Action-6: The center section of the 2D lateral view of the shaft consists of a 3.63-inch long iron shove-on portion, which is followed by a spline section with a diameter ranging from 1.197 to 1.195 inches over four splines positioned at 90 degrees. The knurled portion has a diameter of 1.193 to 1.191 inches, while the spline diameter ranges from 1.200 to 1.196 inches. The knurl features 14 TPI annular knurling or an 8-line spline. This central portion is critical for torque transmission and secure mating with components, ensuring a precise fit along the shaft. Chamfers of 0.03×45° are applied at both ends to enhance ease. of assembly and reduce sharp edges.
Thought+Action-7: The right section of the 2D lateral view of the shaft starts with a 1.50-inch long keyway that is 0.188 inches wide. This section features diameters transitioning from 0.983 to 0.981 inches, followed by a reduced diameter ranging from 0.8750 to 0.8745 inches, and further narrowing to 0.771 to 0.756 inches at the shaft tip. The total length of this section is 3.432 inches, with a 2.250-inch segment before the keyway. This section also references the undercut detail for further machining specifications, ensuring a precise fit for assembly and mechanical performance.

Method 400B, at 482, includes processor 204 providing the user query of 402, Thought+Action pairs of previous iterations (e.g., 434, 436, 438 and 440 of 400A) and three “Thought+Action” pairs 476, 478 and 480 as input to a VRM, such as VRM 112 described herein. The VRM performs evaluation of the user query of 402 and the “Thought+Action” pairs to generate observation 482. In this example, none of the “Thought+Action” pairs need further analysis. The VRM aggregates the “Thought+Action” pairs from previous iterations (e.g., Iteration of 400A) into the current iteration to create a comprehensive answer to the user query.

Observation 484: The 2D shaft diagram's left, center, and right sections are well-defined with key features such as the keyways, knurled and spline portions, precise diameter transitions, and chamfers for smooth assembly. The left section includes a 1.50-inch keyway and undercut, the center features 14 TPI annular knurling and splines, and the right section shows further diameter reductions with another keyway. No further analysis is needed as the diagram provides clear, detailed specifications for manufacturing and assembly.

At 486, it is determined that no further reasoning is required (“NO”). In this example, processor 204, at 448 generates a final response, which may be provided as output to a user.

Final Response: The shaft, manufactured by Baldor Electric Co., is a 35PM 143-5TCZ TEFC 2 Pole model made from 1.188-inch diameter cold-rolled steel (C.R. Steel). Tolerances include ±0.020 inches for 2-place decimals, ±0.005 inches for 3-place decimals, ±0.5°for angular tolerance, and ±0.015 inches for radius tolerance. The front end (FR) undercut details consist of a 0.055-inch radius, a 30° undercut angle, a vertical dimension of 0.031 inches, and a horizontal clearance of 0.083 inches, which must be machined to precise angles and clearances. The power unit (PU) end undercut follows the same dimensions as the front undercut, ensuring symmetry and proper fitment on either side. The shaft itself has several key sections and dimensions along its length. The left end section contains a keyway that is 0.188 inches wide and 1.50 inches long, centered on the shaft, with diameters ranging from 0.517 to 0.502 inches and a 0.03-inch radius undercut. This is followed by a knurled section with diameters from 0.926 to 0.920 inches, and this section is 1.750 inches from the leftmost edge to the start of the knurled portion. The central spline section is 5.011 inches long with a diameter over the spline of 1.197 to 1.195 inches, featuring 4 splines placed at 90° angles. This is followed by another knurled section with a diameter ranging from 1.193 to 1.191 inches over the knurl, with a 14 TPI annular knurl or 8-line spline to ensure a good grip for mating components. Moving to the iron shove-on section, it is 3.63 inches in length, with diameters from 0.983 to 0.981 inches. This connects the central spline to the right end of the shaft and is designed for “shove-on” iron fittings. The right end section contains another 0.188-inch wide and 1.50-inch long keyway, and the undercut details here are similar to the left end. Diameters in this section range from 0.983 to 0.981 inches, transitioning into 0.8750 to 0.8745 inches, and narrowing further to 0.771 to 0.756 inches at the shaft tip. Both ends of the shaft feature 0.03×45° chamfers to ensure proper edge finishing. The central section with splines and knurls is crucial for torque transmission and mating with corresponding components, while the keyways at both ends allow for the insertion of a key to lock the shaft into place within a rotating mechanism. Chamfers on both ends ensure smooth assembly and reduce the risk of sharp edges or misalignment during fitting. The FR and PU undercuts ensure precise cutouts for any attachments or secondary components requiring specific clearances.

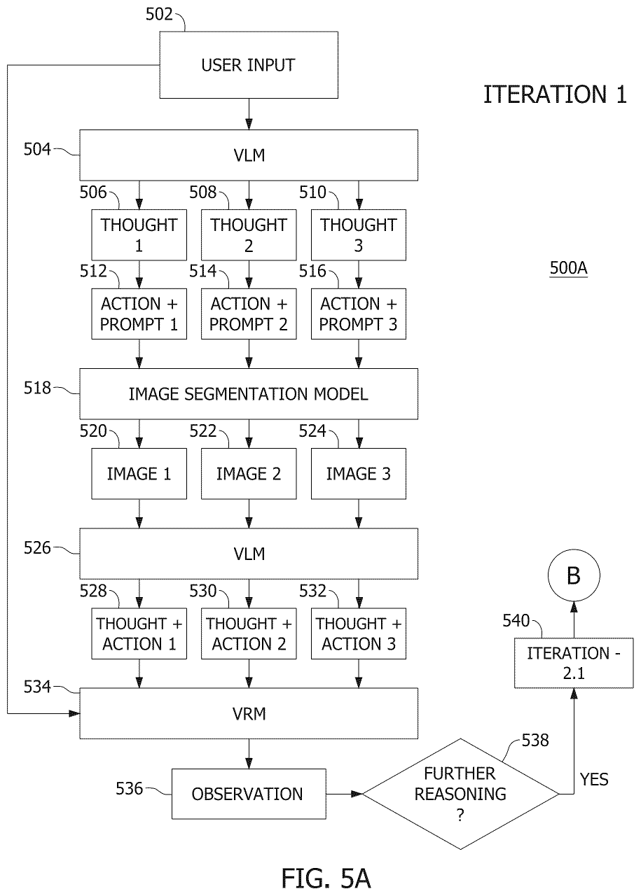

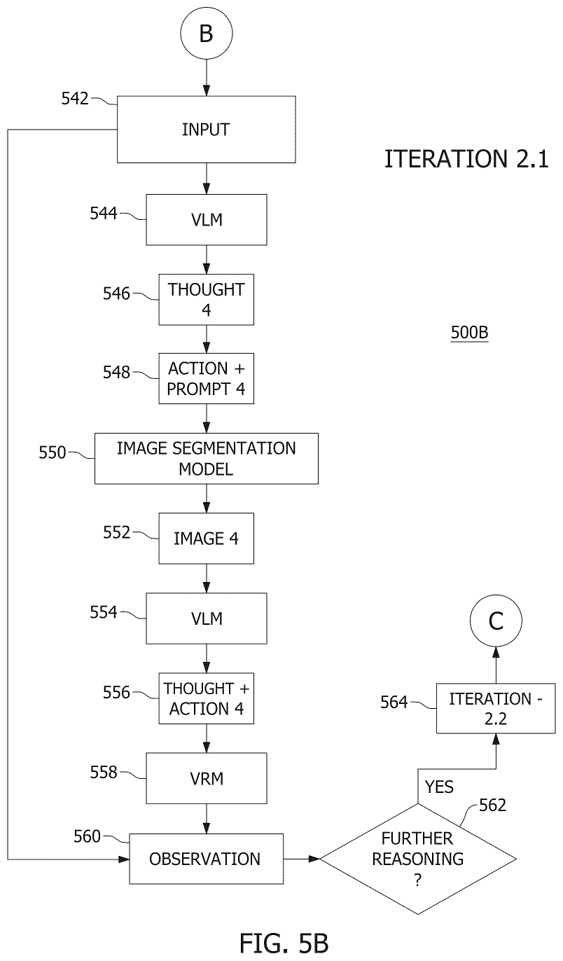

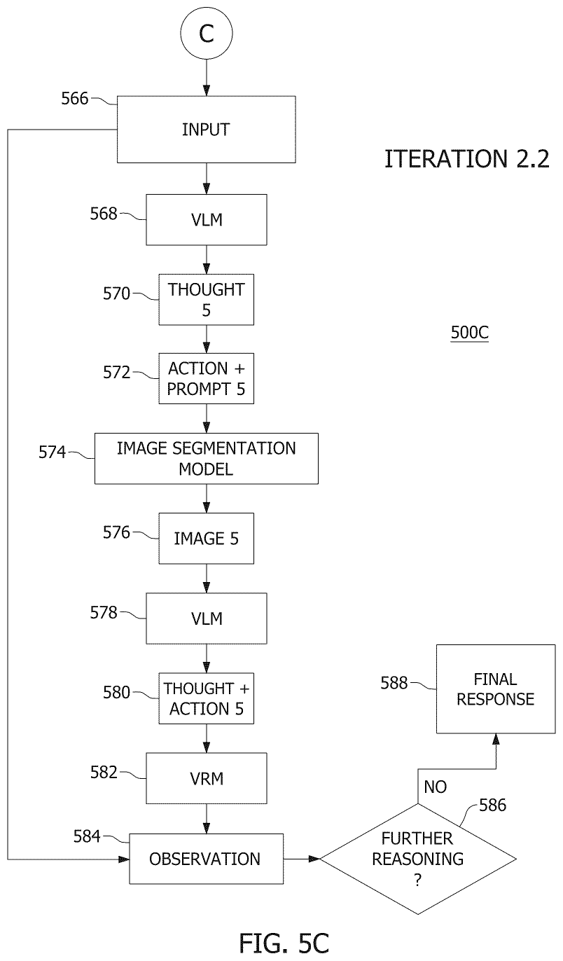

In one example, FIGS. 5A-5B illustrate a detailed example in accordance with one embodiment is provided of analysis of a road scene. FIGS. 5A-5B are described in the context of the computing system described in FIGS. 1 and 2. The flow diagrams of method 500A, 500B and 500C refer to sample images provided in FIGS. 6J-6O. Methods 500A, 500B and 500C may be implemented by processor 204 of computing device 200 (shown in FIG. 2) where computing device 200 is an instance of OPTIC system server 102 (shown in FIG. 1). In this example, analysis is performed of a road scene image illustrated in FIG. 6J. FIG. 5A, method 500A, is a first iteration which performs a general analysis of each segment. FIG. 5B, method 500B, is a second iteration which provides further analysis of grass fields on the right side of the image. FIG. 5C, method 500C is a third iteration which provides analysis of the road ahead and potential for turning.

Method 500A, at 502, includes processor 204 receiving user input. The user input includes a query (“Can I turn Left or Right?”) and an image (see FIG. 6J). In this example, a user may provide an image as input, such as via a client device. The image may be, for example, of a road scene that is captured by a camera, such as a dash cam.

Method 500A, at 504, includes processor 204 providing the user input to a VLM, such as VLM 108 described herein and above. The VLM provides three “thoughts” based on visual reasoning and analysis of the input image and the input query, Thought-1 506, Thought-2 508 and Thought-3 510.
Thought-1: User asked if he can turn left or right, so let us analyze what is present on left side of the image
Thought-2: User asked if he can turn left or right, so let us analyze what is present on Right side of the image
Thought-3: User asked if he can turn left or right, so let us analyze what is present straight ahead of the road

Processor 204 creates segmentation prompts for each thought, Action+Prompt-1 512, Action+Prompt-2 514 and Action+Prompt-3 516.
Action+Prompt-1: segment right and center of the image
Action+Prompt-2: segment Left and center of the image
Action+Prompt-3: segment right and left of the image

Method 500A, at 518, includes processor 204 providing three Action+Prompts 512, 514 and 516 and the input image (see FIG. 6J) to an image segmentation model, such as PBISM 110 described herein. The image segmentation model, using the instructions provided by the three Action+Prompts, generates three images 520, 522 and 524, examples of which are illustrated in FIGS. 6K, 6L and 6M, respectively. Three images 520, 522 and 524 illustrate different regions of interest of the original input image shown in FIG. 6J.

Method 500A, at 526, includes processor 204 providing three images 520, 522 and 524 as input to the VLM for image processing and analysis. At 526, three images 520, 522 and 524 are subjected to visual processing as described herein in conjunction with VLM 108. A “Thought+Action” is generated by the VLM for each input image. For example, Thought+Action-1 528, Thought+Action-2 530 and Thought+Action-3 532 are generated for images 520, 522 and 524, respectively.
Thought+Action-1: It appears that there are two cars present on the left side
Thought+Action-2: It appears that there are no objects present in the right side except grass
Thought+Action-3: It appears that there are three cars present ahead, but none of them are close

Method 500A, at 534, includes processor 204 providing the user query of 502 and three “Thought+Action” pairs 528, 530 and 532 as input to a VRM, such as VRM 112 described herein. The VRM performs evaluation of the user query of 502 and three “Thought +Action” pairs 528, 530 and 532 to generate an observation, such as observation 536.

Observation 536: it is observed that there is a car towards the immediate left and there are no objects towards right and center ahead

At 538, it is determined that further reasoning is required (“YES”). In this example, “Thought+Action” pair 530 is determined to require further analysis. At 540, “Thought+Action” pair 530 and its corresponding image 522 are sent for a new iteration, which is described in FIG. 5B, method 500B.

Method 500B, at 542, includes processor 204 receiving input. The input includes the original query (“Can I turn Left or Right?”), observation 536, Thought+Action pairs of previous iterations (e.g., 528, 530, 532) and image 522 (see FIG. 6L).

Method 500B, at 544, includes processor 204 providing the input to a VLM, such as VLM 108 described herein and above. The VLM provides a “thought” based on visual reasoning and analysis of the input provided at 542: Thought-4 546.
Thought-4: Further check if we can turn safely on grass fields

Processor 204 creates a segmentation prompt for Thought-4 546, Action+Prompt-4 548.
Action+Prompt-4: segment Left and center of the image

Method 500B, at 550, includes processor 204 providing Action+Prompt-4 548 and image 522 to an image segmentation model, such as PBISM 110 described herein. The image segmentation model, using the instructions provided by Action+Prompt-4 548, generates image 4 552, an example of which is illustrated in FIG. 6N. The image illustrates a region of interest of the input image shown in FIG. 6L.

Method 500B, at 554, includes processor 204 providing image 4 552 as input to the VLM for processing. At 554, the image is subjected to visual processing as described herein in conjunction with VLM 108. A “Thought+Action” pair 556 is generated by the VLM for the input image. For example, Thought+Action-4 556 is generated for image 552.
Thought+Action-4: It appears that there are no objects present in the right side except grass.

Method 500B, at 558, includes processor 204 providing the user query of 502, Thought+Action pairs of previous iterations (e.g., 528, 530, 532), and Thought+Action-4 556 as input to a VRM, such as VRM 112 described herein. The VRM performs evaluation of the user query of 502 and the “Thought+Action” pairs to generate observation 560.

Observation 560: For ordinary cars it is difficult to turn/navigate in grass fields. Also, we can move slightly forwards and then we have some free space to turn left

At 562, it is determined that further reasoning is required (“YES”). In this example, “Thought+Action” pair 532 is determined to require further analysis. At 564, “Thought+Action” pair 532 and its corresponding image 524 are sent for a new iteration, which is described in FIG. 5C, method 500C.

Method 500C, at 566, includes processor 204 receiving input. The input includes the original query (“Can I turn Left or Right?”), observation 560, Thought+Action pairs of previous iterations (e.g., 528, 530, 532, 556) and image 524 (see FIG. 6M).

Method 500C, at 568, includes processor 204 providing the input to a VLM, such as VLM 108 described herein and above. The VLM provides a “thought” based on visual reasoning and analysis of the input provided at 566: Thought-5 570.
Thought-5: can we move slightly ahead and then turn left?

Processor 204 creates a segmentation prompt for Thought-5 570, Action+Prompt-5 572.
Action+Prompt-5: segment top 40% of center portion

Method 500C, at 574, includes processor 204 providing Action+Prompt-5 572 and image 524 to an image segmentation model, such as PBISM 110 described herein. The image segmentation model, using the instructions provided by Action+Prompt-5 572, generates image 5 576, an example of which is illustrated in FIG. 6O. The image illustrates a region of interest of the input image 524 shown in FIG. 6M.

Method 500C, at 578, includes processor 204 providing image 5 576 as input to the VLM for processing. At 578, image 5 576 is subjected to visual processing as described herein in conjunction with VLM 108. A “Thought+Action” pair is generated by the VLM for the input image. For example, Thought+Action-5 580 is generated for image 5 576.
Thought+Action-5: There appears to be free space to turn left if we move slightly forwards.

Method 500C, at 582, includes processor 204 providing the user query of 502, Thought+Action pairs of previous iterations (e.g., 528, 530, 532, 556), and Thought+Action-5 580 as input to a VRM, such as VRM 112 described herein. The VRM performs evaluation of the user query of 502 and the “Thought+Action” pairs to generate observation 584. In this example, the VRM aggregates the “Thought+Action” pairs from previous iterations (e.g., Iterations of 500A and 500B) into the current iteration to create a comprehensive answer to the user query.

Observation 584: For ordinary cars it is difficult to turn/navigate in grass fields. Also, we can move slightly forwards and then we have some free space to turn left.

At 586, it is determined that no further reasoning is required (“NO”). In this example, processor 204, at 588 generates a final response, which may be provided as output to a user. As a final response, the system may generate a comprehensive response, indicating that immediate left turns are not possible due to oncoming traffic, right turns are challenging due to grass fields, but a slight forward movement followed by a left turn is feasible.

Final Response: We cannot turn immediately towards left. Also, there are grass fields towards right, and majority of the cars face difficulty navigating in grass fields. So, we cannot turn left or right immediately, but, we can slightly move forwards and then we have some free space to turn left.

In some embodiments, prompt formats may be used by the disclosed methods and systems. For example, a sample prompt during initial thought generation performed by the VLM may be: Prompt: “Analyze the given image in the context of the query: ‘{query}’. Generate 3-5 distinct thoughts about different aspects of the image that are relevant to answering this query. Each thought should focus on a specific area or feature of the image. Format your response as a numbered list.”

For image segmentation performed by the VLM, a sample prompt may be: Prompt: “For each of the following thoughts, create a specific segmentation prompt that will guide the image segmentation tool to focus on the relevant area of the image: {thoughts_list} Segmentation prompts should be clear, concise, and directly instruct what part of the image to focus on. Format each prompt as ‘Segment: [instruction]’.”

For focused analysis for Thought+Action Pairs performed by the VLM, a sample prompt may be: Prompt: “Analyze the following segmented image in the context of the original query ‘{query}’ and the specific thought ‘{current_thought}’. Provide a detailed description of what you observe in this image segment and suggest a relevant action based on this observation. Format your response as: Thought: [Your detailed observation] Action: [Suggested action based on the observation]”

For the visual reasoning moderator and selection and further analysis performed by the VRM, a sample prompt may be Prompt: “Review the following Thought+Action pairs generated from the image analysis: {thought_action_pairs} Perform the following tasks: 1) Rank these pairs from most to least relevant to the query ‘{query}’, 2) Identify any contradictions or complementary information among the pairs, 3) Determine if any areas require further analysis. If so, specify which aspects need more attention, and 4) Suggest how to combine insights from these pairs to form a comprehensive understanding. Format your response with numbered sections for each task.”

For the iteration Decision performed by the VRM, a sample prompt may be: Prompt: “Based on the current analysis and the original query ‘{query}’, determine if further iteration is necessary. Consider: Have all relevant aspects of the image been thoroughly analyzed? Is the current information sufficient to provide a comprehensive answer? Are there any ambiguities or uncertainties that require clarification? Provide a yes/no decision on whether to perform another iteration, followed by a brief explanation.”

For the generating new thoughts for next iteration performed by the VLM, a sample prompt may be: Prompt: “Given the insights from the previous iteration: {previous_iteration_summary} Generate 2-3 new, more focused thoughts to guide the next iteration of analysis. These thoughts should address any gaps in understanding or explore aspects that require deeper investigation to better answer the query ‘{query}’. Format as a numbered list.”

For the observation generation performed by the VLM, a sample prompt may be: Prompt: “Synthesize the key findings from all iterations of analysis regarding the query ‘{query}’. Provide a concise yet comprehensive observation that captures the most important insights derived from the image analysis. Your observation should directly address the user's query and incorporate relevant details from various parts of the image.”

For the final response formulation performed by the VRM, a sample prompt may be: Prompt: “Using all the information gathered through the iterative analysis process, including: {all_iterations_summary} Formulate a detailed, coherent response to the original query ‘{query}’. Your response should: Directly address the user's question, incorporate key insights from different parts of the image, explain any relevant reasoning or decision-making processes, and highlight any uncertainties or alternative interpretations, if applicable. Ensure that your response is clear, well-structured, and provides a comprehensive answer based on the visual analysis.”

The term “non-transitory,” as used herein, is a limitation of the medium itself (i.e., tangible, not a signal) as opposed to a limitation on data storage persistency (e.g., RAM vs. ROM).

As used in this application, the term “circuitry” may refer to one or more or all of the following: (a) hardware-only circuit implementations (such as implementations in only analog and/or digital circuitry) and (b) combinations of hardware circuits and software, such as (as applicable): (i) a combination of analog and/or digital hardware circuit(s) with software/firmware and (ii) any portions of hardware processor(s) with software (including digital signal processor(s)), software, and memory(ies) that work together to cause an apparatus, such as a mobile phone or server, to perform various functions) and (iii) hardware circuit(s) and or processor(s), such as a microprocessor(s) or a portion of a microprocessor(s), that requires software (e.g., firmware) for operation, but the software may not be present when it is not needed for operation.”

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

It should be understood that the foregoing description is only illustrative. Various alternatives and modifications can be devised by those skilled in the art. For example, features recited in the various dependent claims could be combined with each other in any suitable combination(s). In addition, features from different embodiments described above could be selectively combined into a new embodiment. Accordingly, the description is intended to embrace all such alternatives, modifications and variances which fall within the scope of the appended claims.

What is claimed is:

1. An apparatus comprising:
at least one processor; and
at least one memory including computer program code, the at least one memory and the computer program code configured to, with the at least one processor, cause the apparatus at least to:
receive an image and at least one query;
generate, using a first vision-language model, one or more first perceptual thoughts related to one or more aspects of the image potentially relevant to the at least one query;
determine, for each first perceptual thought of the one or more first perceptual thoughts, a first image processing action associated with the first perceptual thought;
process the image according to each first image processing action to generate one or more first filtered images from the image;
analyze, by the first vision-language model, the one or more first filtered images to generate one or more second perceptual thoughts, the first vision-language model configured to generate, for each first filtered image, a second perceptual thought related to one or more aspects of the first filtered image potentially relevant to the at least one query; and
generate, using the one or more second perceptual thoughts, a response to the at least one query.

2. The apparatus of claim 1, wherein the computer program code is configured to, with the at least one processor, further cause the apparatus at least to:
analyze, by a second vision-language model, the one or more second perceptual thoughts;
determine, by the second vision-language model, for a second perceptual thought associated with a corresponding first filtered image, a second image processing action to be applied to the corresponding first filtered image;
process the corresponding first filtered image according to the second image processing action to generate a second filtered image; and
analyze, by the first vision-language model, the second filtered image to generate a third perceptual thought related to one or more aspects of the second filtered image potentially relevant to the at least one query, the response to the at least one query generated further based on the third perceptual thought.

3. The apparatus of claim 2, wherein the one or more second perceptual thoughts are analyzed in view of the at least one query.

4. The apparatus of claim 2, wherein the one or more second perceptual thoughts are analyzed by ranking the one or more second perceptual thoughts from most to least relevant to the at least one query, identifying any contradictions or complementary information among the one or more second perceptual thoughts, or suggesting how to combine insights from the one or more second perceptual thoughts to form a comprehensive understanding.

5. The apparatus of claim 1, wherein the computer program code is configured to, with the at least one processor, further cause the apparatus at least to:
determine, for each first perceptual thought of the one or more first perceptual thoughts, a first prompt to trigger the first image processing action.

6. The apparatus of claim 1, wherein the first vision-language model is a neural network trained to relate one or more aspects of an input image to a text-based input query.

7. The apparatus of claim 1, wherein the first processing action includes an instruction to segment or crop an image to generate a filtered image.

8. A method comprising:
receiving an image and at least one query;
generating, using a first vision-language model, one or more first perceptual thoughts related to one or more aspects of the image potentially relevant to the at least one query;
determining, for each first perceptual thought of the one or more first perceptual thoughts, a first image processing action associated with the first perceptual thought;
processing the image according to each first image processing action to generate one or more first filtered images from the image;
analyzing, by the first vision-language model, the one or more first filtered images to generate one or more second perceptual thoughts, the first vision-language model configured to generate, for each first filtered image, a second perceptual thought related to one or more aspects of the first filtered image potentially relevant to the at least one query; and
generating, using the one or more second perceptual thoughts, a response to the at least one query.

9. The method of claim 8, further comprising:
analyzing, by a second vision-language model, the one or more second perceptual thoughts;
determining, by the second vision-language model, for a second perceptual thought associated with a corresponding first filtered image, a second image processing action to be applied to the corresponding first filtered image;
processing the corresponding first filtered image according to the second image processing action to generate a second filtered image; and
analyzing, by the first vision-language model, the second filtered image to generate a third perceptual thought related to one or more aspects of the second filtered image potentially relevant to the at least one query, the response to the at least one query generated further based on the third perceptual thought.

10. The method of claim 9, wherein the one or more second perceptual thoughts are analyzed in view of the at least one query.

11. The method of claim 9, wherein the one or more second perceptual thoughts are analyzed by ranking the one or more second perceptual thoughts from most to least relevant to the at least one query, identifying any contradictions or complementary information among the one or more second perceptual thoughts, or suggesting how to combine insights from the one or more second perceptual thoughts to form a comprehensive understanding.

12. The method of claim 8, further comprising:
determining, for each first perceptual thought of the one or more first perceptual thoughts, a first prompt to trigger the first image processing action.

13. The method of claim 8, wherein the first vision-language model is a neural network trained to relate one or more aspects of an input image to a text-based input query.

14. The method of claim 8, wherein the first processing action includes an instruction to segment or crop an image to generate a filtered image.

15. An apparatus comprising:
at least one processor; and
at least one memory including computer program code, the at least one memory and the computer program code configured to, with the at least one processor, cause the apparatus at least to:
generate, with a vision-language model, one or more first perceptual thoughts related to one or more aspects of an image and at least one query;
create a filtered image for each of the one or more first perceptual thoughts based at least in part on the one or more first perceptual thoughts;
generate, with the vision-language model, a second perceptual thought for each filtered image of the one or more first perceptual thoughts; and
determine a response to the at least one query based at least in part on the one or more perceptual thoughts and the one or more second perceptual thoughts.

16. The apparatus of claim 15, wherein the computer program code is configured to, with the at least one processor, further cause the apparatus at least to:
create another filtered image of a filtered image corresponding to at least one of the one or more second perceptual thoughts; and
analyze, by the vision-language model, the another filtered image to generate a third perceptual thought related to one or more aspects of the another filtered image, the response to the at least one query determined further based on the third perceptual thought.

17. The apparatus of claim 16, wherein the one or more second perceptual thoughts are analyzed in view of the at least one query by the vision-language model.

18. The apparatus of claim 16, wherein the one or more second perceptual thoughts are analyzed by ranking the one or more second perceptual thoughts from most to least relevant to the at least one query, identifying any contradictions or complementary information among the one or more second perceptual thoughts, or suggesting how to combine insights from the one or more second perceptual thoughts to form a comprehensive understanding.

19. The apparatus of claim 15, wherein the first vision-language model is a neural network trained to relate one or more aspects of an input image to a text-based input query.

20. The apparatus of claim 15, wherein the image is segmented or cropped to create the filtered image.
